(19) United States
(12) Patent Application Publication
(10) Pub. No.: US 2026/0366583 A1
(43) Pub. Date: Nov. 19, 2026

(54) RESILIENT MOTOR BRAKE

(71) Applicant: DISNEY ENTERPRISES, INC., Burbank, CA (US)

(72) Inventors: Alan Hong, Glendale, CA (US); Michael James Wodnicki, Burbank, CA (US); Robert Lyle, Burbank, CA (US); Tanner Rinke, Winter Garden, FL (US)

(21) Appl. No.: 19/668,780

(22) Filed: May 5, 2026

Related U.S. Application Data
(60) Provisional application No. 63/808,515, filed on May 19, 2025.

(51) Int. Cl. F16D 63/00; F16D 65/00; F16D 65/16; H02K 7/102; F16D 121/20

(52) U.S. Cl. CPC F16D 63/006; F16D 65/0043; F16D 65/16; H02K 7/1025; F16D 2121/20

(57) ABSTRACT

An electric motor braking assembly includes: a disc coupled to a motor shaft, the disc having a circumferential array of teeth; an actuator assembly including: a pin selectively deployable to interfere with at least one tooth of the circumferential array of teeth, a solenoid configured to move the pin between a deployed position in which the pin interferes with the at least one tooth of the circumferential array of teeth, and a retracted position in which the pin does not interfere with the at least one tooth of the circumferential array of teeth, a first resilient element coupled to at least one of the pin or the disc and configured to allow a rotational slipping motion of the pin relative to the at least one tooth of the circumferential array of teeth when the pin is in the deployed position.

### CROSS REFERENCE TO RELATED APPLICATIONS

This application claims the benefit of priority under 35 U.S.C. § 119(e) and 37 C.F.R. § 1.78 to U.S. Provisional Patent Application No. 63/808,515 filed on May 19, 2025, titled “RESILIENT MOTOR BRAKE,” which is hereby incorporated by reference herein in its entirety.

### BACKGROUND

Existing electric motor brakes are typically electrically-released, spring-applied brake systems that use a friction contact surface as the braking element. These are too large for many compact applications such as vehicles, robotic systems, etc. Furthermore, such braking systems generate a considerable amount of heat to hold the brake in released state. Some pin-and-cog style motor brakes exist to overcome these challenges. However, a significant drawback to these systems is the potential damage to the brake system if the pin-style brake is deployed when the motor is at non-zero speed. Improved motor brakes are desired.

### BRIEF SUMMARY

In one embodiment, an electric motor braking assembly is provided. The electric motor braking assembly includes a disc coupled to a motor shaft. The disc has a circumferential array of teeth. The electric motor braking assembly includes an actuator assembly. The actuator assembly includes a pin selectively deployable to interfere with at least one tooth of the circumferential array of teeth. The actuator assembly includes a solenoid configured to move the pin between a deployed position in which the pin interferes with the at least one tooth of the circumferential array of teeth, and a retracted position in which the pin does not interfere with the at least one tooth of the circumferential array of teeth. The actuator assembly includes a first resilient element coupled to at least one of the pin or the disc and configured to allow a rotational slipping motion of the pin relative to the at least one tooth of the circumferential array of teeth when the pin is in the deployed position.

Optionally, in some embodiments, the electric motor braking assembly further includes a second resilient element configured to allow a longitudinal skipping motion of the pin relative to the at least one tooth of the circumferential array of teeth.

Optionally, in some embodiments, the disc includes an inner hub and an outer hub connected by a resilient element that allows angular movement therebetween.

Optionally, in some embodiments, at least one of the first resilient element or the second resilient element includes a coil spring.

Optionally, in some embodiments, the pin includes a body with a head portion at one end of the body and a tail portion at an opposite end of the body.

Optionally, in some embodiments, the pin includes a cam adjacent to the head portion configured to engage with the at least one tooth of the circumferential array of teeth.

Optionally, in some embodiments, the at least one tooth of the circumferential array of teeth includes a tooth bevel, and the cam includes a complementary cam bevel.

Optionally, in some embodiments, the cam bevel and the tooth bevel are configured to meet at a contact point when the pin is in the deployed position.

Optionally, in some embodiments, the body includes a bulkhead extending therefrom, and the pin further includes a retainer extending between the cam and the bulkhead.

Optionally, in some embodiments, the body includes a bulkhead extending therefrom, and the bulkhead is configured to pretension the first resilient element.

Optionally, in some embodiments, the first resilient element includes a torsion spring.

Optionally, in some embodiments, the second resilient element includes a compression spring.

Optionally, in some embodiments, the first resilient element includes a torsion spring, and the second resilient element includes a compression spring.

In one embodiment, a removal tool for use with the electric motor braking assembly is provided. The removal tool is configured to disengage the electric motor braking assembly. The removal tool includes a threaded portion coupled to a knob.

Optionally, in some embodiments, the threaded portion is configured to engage an armature of the solenoid to draw the pin away from the disc.

In one embodiment, a method of operating a braking assembly is provided. The method includes detecting, via a processing element, a failure condition in a servo system. The method includes determining, via the processing element, whether the braking assembly is controllable. Responsive to determining that the braking assembly is controllable, the method includes evaluating, via the processing element, a risk of damage to the braking assembly. The method includes delaying, via the processing element, deployment of the braking assembly until the risk of damage is below a threshold.

Optionally, in some embodiments, the braking assembly further includes a pin and a disc. The disc includes a circumferential array of teeth. The method further includes, responsive to determining, via the processing element, that the braking assembly is not controllable, automatically deploying the braking assembly by moving the pin to a deployed position that allows a rotational slipping motion of the pin relative to at least one tooth of the circumferential array of teeth.

Optionally, in some embodiments, the braking assembly further includes a pin, a disc having a circumferential array of teeth, and a first resilient element coupled to the pin. The method further includes deploying the braking assembly by moving the pin to a deployed position that allows a rotational slipping motion of the pin relative to at least one tooth of the circumferential array of teeth.

Optionally, in some embodiments, the braking assembly further includes a second resilient element. The method further includes deploying the braking assembly by moving the pin to a deployed position that allows a longitudinal skipping motion of the pin relative to the at least one tooth of the circumferential array of teeth when the pin is in the deployed position.

In one embodiment, an electric motor braking assembly is provided. The electric motor braking assembly includes a disc coupled to a motor shaft. The disc has a circumferential array of tines. The electric motor braking assembly includes an actuator assembly. The actuator assembly includes a pin selectively deployable to interfere with at least one tine of the circumferential array of tines. The actuator assembly includes a solenoid configured to move the pin between a deployed position in which the pin interferes with the at least one tine of the circumferential array of tines, and a retracted position in which the pin does not interfere with the at least one tine of the circumferential array of tines. The tines of the circumferential array of tines are configured to allow a rotational slipping motion of the pin relative to the at least one tine of the circumferential array of tines when the pin is in the deployed position.

### BRIEF DESCRIPTION OF THE DRAWINGS

FIG. 1 is a partially-exploded view of a servo system including a motor and a braking assembly.

FIG. 2 is an isometric view of an embodiment of the braking assembly of the servo system of FIG. 1.

FIG. 3 is a section view of a portion of the braking assembly of FIG. 2 taken along line 3-3 of FIG. 2.

FIG. 4 is an isometric view of a portion of the braking assembly of FIG. 2 with the housing hidden.

FIG. 5 is a detailed isometric view of a portion of the braking assembly of FIG. 2.

FIG. 6 is an end elevation view of the braking assembly of FIG. 2 with the cam shown in a neutral position.

FIG. 7A is an isometric view of the braking assembly of FIG. 2 in a first braking configuration.

FIG. 7B is an isometric view of the braking assembly of FIG. 2 in a second braking configuration.

FIG. 8 illustrates an example of a removal to suitable to disengage a braking assembly.

FIG. 9 is a flow chart of a method of operating the braking assembly of FIG. 2.

FIG. 10 is an isometric view of another embodiment of a braking assembly according to the present disclosure.

FIG. 11 is an isometric view of another embodiment of a braking assembly according to the present disclosure.

FIG. 12 is an isometric view of another embodiment of a braking assembly according to the present disclosure.

FIG. 13 is an isometric view of another embodiment of a braking assembly according to the present disclosure.

FIG. 14 is an isometric view of another embodiment of a braking assembly according to the present disclosure.

FIG. 15 is a simplified block diagram of components of a computing system suitable to control the servo of FIG. 1 and/or the braking assembly of FIG. 2.

### DETAILED DESCRIPTION

The disclosed braking systems and methods provide many benefits over traditional friction or pin-based braking systems. For example, the disclosed systems: reduce integrated brake size compared to existing systems; reduce brake system power consumption while the brake is in a release state; reduce damage to the assembly in which the brake is deployed while the motor is spinning; and/or increase modularity for use in varying applications, compared to previous braking systems.

The disclosed systems include a disc (often a toothed disc in many embodiments) coupled to the motor. A selectively deployable pin can be extended to interfere with the disc to slow or prevent the motor from spinning.

In one embodiment, the pin can skip and/or slip with respect to the disc to reduce damage to the system if the brake is deployed while the motor is spinning (compared to previous pin-style brakes). In such embodiments, the pin and the disc can have faceted or chamfered edges that interact with one another.

Skipping: In the event that the disc and motor shaft are spinning when the pin advances to interfere with the rotational path of the disc or its teeth (e.g., when the brake is deployed), the faceted edges of the pin and disc allow for the pin to bounce away from the disc upon impact. The pin will continue to "skip" along the teeth of the disc until the disc reaches a low enough speed to allow for full insertion of the pin into the path of the disc.

Slipping: The slipping feature makes use of compliance in the brake system. In the event that, while the pin is inserted in the path of the disc, torque is applied through the disc teeth onto the pin, the pin may deflect and allow a tooth of the disc to "slip" past before the compliance in the system restores the pin to its original position. The threshold torque applied to enable the pin to “slip” is normally less than the maximum mechanical torque limitation of the load assembly.

Thus, the disclosed systems may have resilient features that operate bidirectionally (many servos can spin in either clockwise or counterclockwise directions). The resilient features operate in a bi-directional fashion, to achieve resilience regardless of the direction of motor velocity or torque. This distinguishes the disclosed systems from unidirectional pawl mechanisms or ratchet mechanisms.

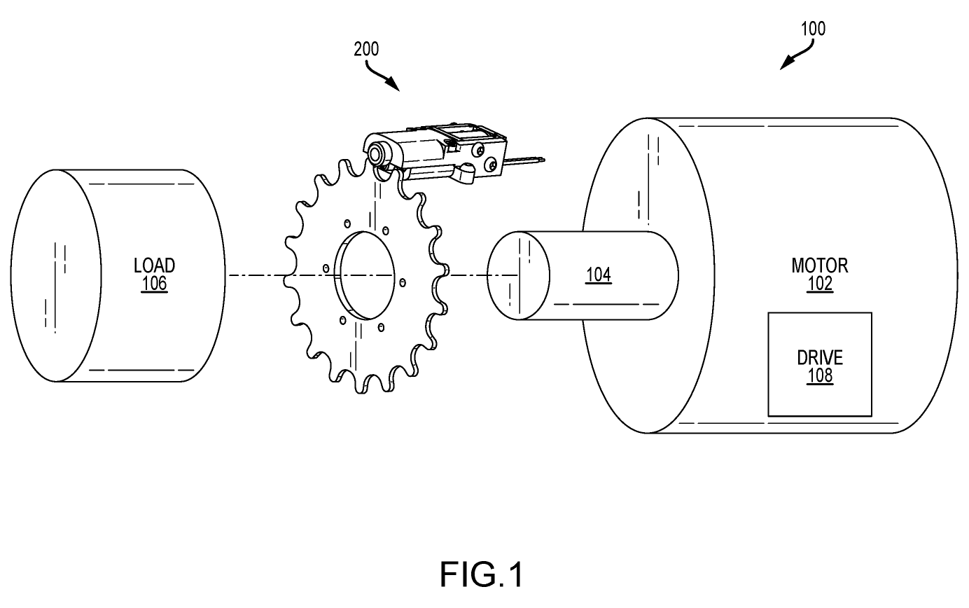

FIG. 1 shows a servo 100 including a motor 102, a drive 108, and a braking assembly 200. The motor 102 includes a shaft 104 that spins with respect to the body of motor 102, as controlled by the drive 108. The drive 108 controls the direction, speed, acceleration, and/or other aspects of the spinning of the shaft 104. The shaft 104 couples to a load 106 and spins the load 106. The load 106 may be a portion of a robotic device (such as a limb, head, torso, gear component, or gear assembly, etc.) whose motion is controlled by the drive 108. The drive 108 includes one or more power circuits that provide electrical power to the windings of the motor 102, and based on the timing and amount of power (e.g., voltage and/or current) supplied, control the spinning of the motor 102 shaft 104.

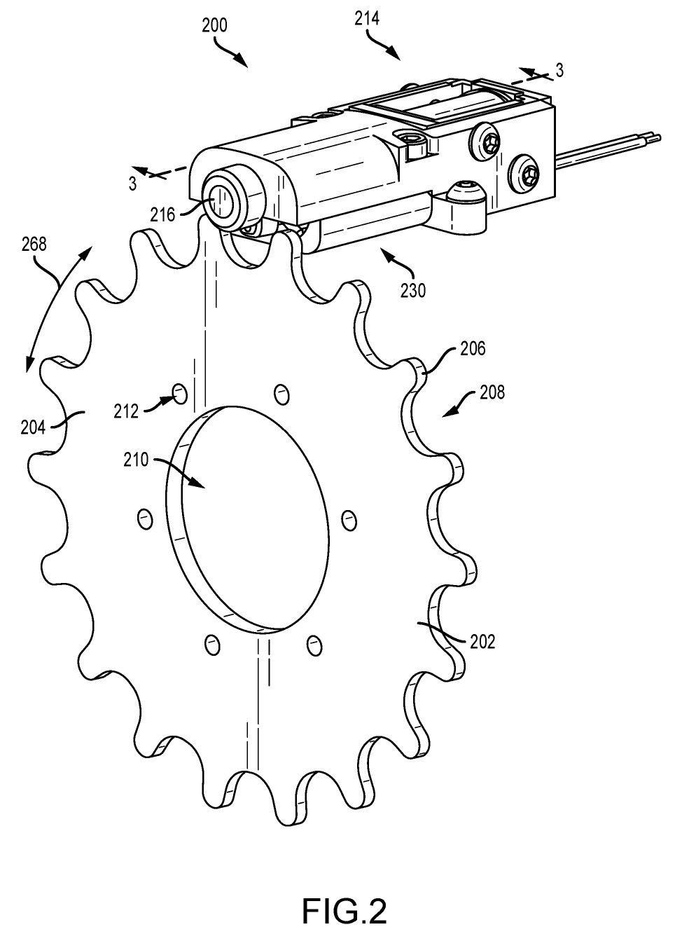

With reference to FIGS. 2 - 5 the components and features of the braking assembly 200 are shown and described. The braking assembly 200 includes a disc 202 and an actuator 214.

The disc 202 is coupled to the shaft 104 of the motor 102 and spins with the shaft 104. The disc 202 includes a main body 204. The main body 204 is typically a thin, planar main body 204 with an overall round shape. The main body 204 may have one or more teeth 206 extending from a circumferential edge thereof. Successive teeth 206 may be separated from one another by a gap 208. In many embodiments, the teeth 206 are evenly spaced about the circumference of the main body 204. The main body 204 may include a main aperture 210 suitable to receive and couple the disc 202 to the shaft 104. The main body 204 may also include one or more optional fastener apertures 212 suitable to couple the disc 202 to a flange which is in turn coupled to the shaft 104 of the motor 102.

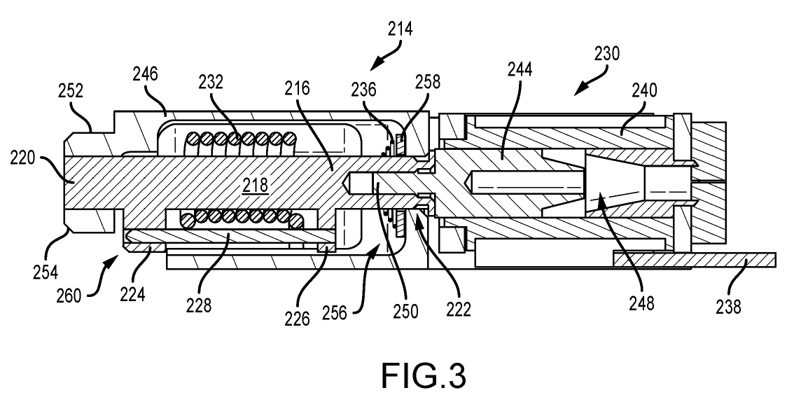

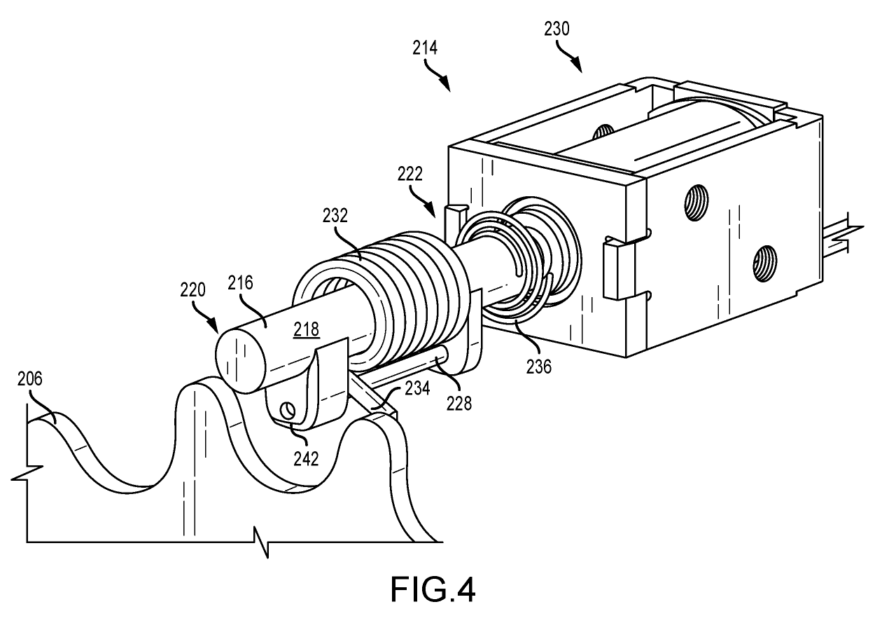

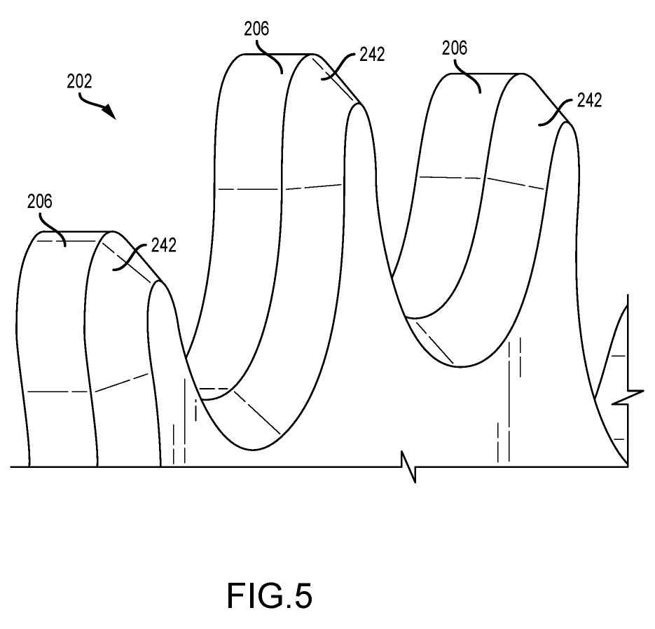

With specific reference to FIGS. 3 and 4, the actuator 214 includes a housing 246 that receives and supports a pin 216 as well as other components. For example, the housing 246 has an internal compartment 256 that receives the pin 216, a first resilient element 232, a second resilient element 236, a washer 258, and a retainer 228. Th housing may have a cap 252 that slidably receives a portion (e.g., a head portion 220 of the pin 216). The cap 252 may include a cap bevel 254 on one or more edges thereof.

The pin 216 includes a body 218 with a head portion 220 at one end and a tail portion 222 at an opposite end of the body 218 from the head portion 220. Extending radially from the body 218 is a cam 224 adjacent to the head portion 220. A bulkhead 226 extends radially from the body 218 between the cam 224 and the tail portion 222. A retainer 228 runs longitudinally with the body 218 between the cam 224 and the bulkhead 226. The ends of the retainer 228 may be received in apertures formed in the cam 224 and the bulkhead 226. The tail portion 222 may include an aperture with threads or other features that enable the tail portion 222 to couple to an armature 244 of a solenoid 230. For example, the armature 244 may include a stem 250 at an end thereof including threads or other coupling features that enable the stem 250 to couple to the tail portion 222 of the pin 216.

The solenoid 230 includes one or more coils 240 electrically coupled to one or more conductors 238 that supply power to the coils 240 to operate the solenoid 230. When power is applied to the coil 240, the armature 244 moves longitudinally in a passage 248 formed in the solenoid 230 with respect to the coil 240. In the assembled actuator 214, this longitudinal movement of the armature 244 causes a corresponding longitudinal movement of the pin 216. In many embodiments, the solenoid 230 includes a biasing element that biases the armature 244 toward a certain direction. When the coil 240 is powered, the armature and coil generate sufficient longitudinal force to overcome the force of the biasing element. In some embodiments, the second resilient element 236 may bias the armature and/or pin toward a desired (e.g., deployed) position.

The actuator 214 includes a first resilient element 232. The first resilient element 232 in the embodiment shown in FIGS. 3 and 4 wraps around the circumference of the pin 216 along at least a portion of the length of the body 218 of the pin 216. In many embodiments, the first resilient element 232 is a torsion spring. The first resilient element 232 may include a tang 234 formed from an uncoiled portion of the wire that forms the main body of the first resilient element 232. The tang 234 may interact with the retainer 228 to pretension the first resilient element 232, as will be described further herein. The first resilient element 232 enables the slipping motion of the cam 224 relative to the teeth 206 of the disc 202.

The actuator 214 includes a second resilient element 236. In the embodiment shown in FIGS. 3 and 4, the second resilient element 236 is a compression spring. The second resilient element 236 provides compliance for the pin 216 in a longitudinal direction and enables the skipping motion of the pin 216 relative to the teeth 206 of the disc 202. The second resilient element 236 may be supported by a washer 258 that interfaces a portion of the second resilient element 236 with the housing 246 of the actuator 214. In the embodiment shown, the second resilient element 236 biases the pin 216 outward from the internal compartment 256 (e.g., toward the cap 252). In other embodiments, the second resilient element 236 may bias the pin 216 in another direction.

With reference to FIGS. 3 and 4, the cam 224 may include a chamfer, facet, or bevel 242 on a leading edge thereof. The bevel 242 may be shaped to complement a corresponding bevel 242 formed on one or more of the teeth 206 of the disc 202, such that in the event of an interference between the cam 224 and the tooth 206, damage to both is minimized.

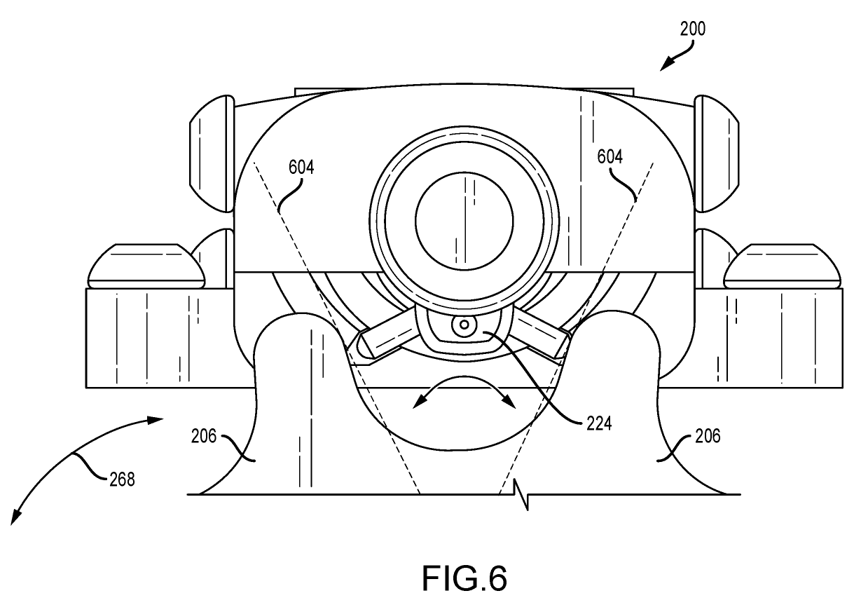

Turning to FIGS. 6 - 7B, the operation of the braking assembly 200 will be described. As the motor 102 spins, the teeth 206 of the disc 202 move along a circular path 268. Depending on the deployment status of the braking assembly 200, the cam 224 may, or may not, interfere with this path 268. As shown for example in FIG. 6, the teeth 206 each have an interference plane 604 that will clash with the cam 224 as the disc 202 rotates either clockwise or counter-clockwise of the solenoid 230.

In many embodiments, the biasing element of the solenoid 230 or second resilient element 236 pushes the armature 244 out of the solenoid 230 and thus causes the pin 216 and cam 224 to be in a position to interfere with the interference planes 604 of the teeth 206. When the solenoid 230 in such embodiments is powered, the pin 216 retracts into the internal compartment 256 and does not interference with the teeth 206. Thus, the actuator 214 in such embodiments is “fail-safe” in that in the event of a loss of power, the pin 216 is automatically deployed into the path 268 of the teeth 206 and the cam 224 contacts the interference planes 604 thereof.

In other embodiments, the biasing element of the actuator 214 may cause the armature 244 and thus the pin 216 to retract into the housing 246 and the pin 216 engages the teeth 206 when the coil 240 is powered.

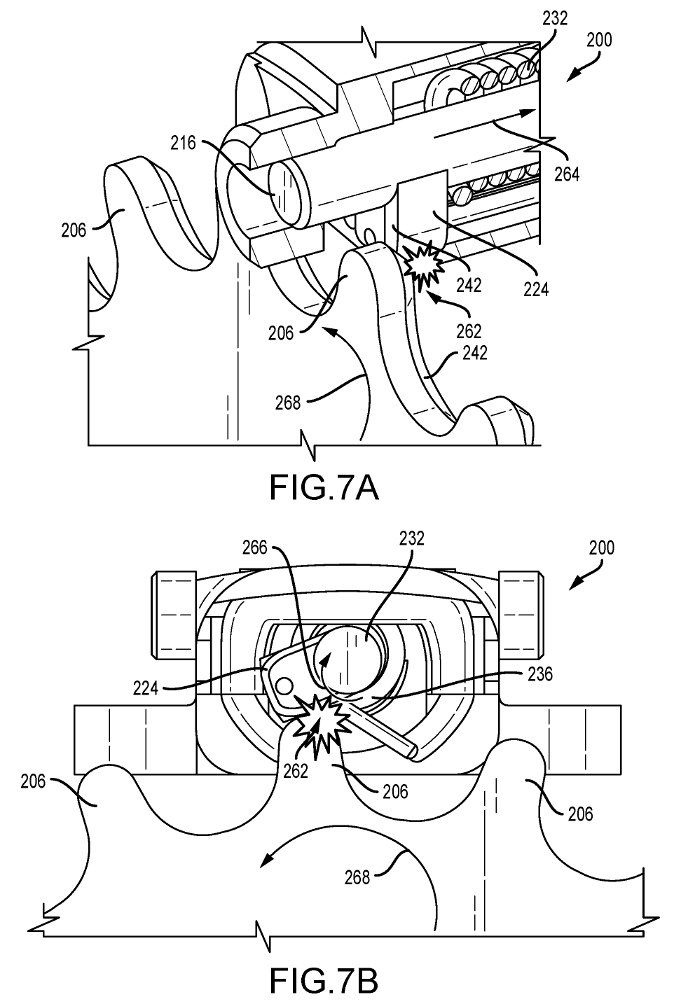

Turning to FIG. 7A, an example of skipping motion is shown. In the example shown, the disc 202 and shaft 104 of the motor 102 are spinning when the brake is deployed (e.g., when the coil 240 is unpowered). The cam 224 is in a position such that the bevel 242 interferes with the interference plane 604 of the teeth 206. The bevel 242 of the tooth 206 and the bevel 242 of the cam 224 make contact at a contact point 262. The shapes of the bevels 242 causes the pin 216 to be forced back into the internal compartment 256, overcoming the biasing of the second resilient element 236 in the longitudinal direction 264. This skipping movement temporarily clears the cam 224 from the path 268 of the teeth 206. Skipping motion may be particularly beneficial when the disc 202 is spinning at a high rate of speed (e.g., in excess of 10 revolutions per minute) preventing the cam 224 from abruptly halting the spinning of the disc 202 and/or motor 102 and preventing or reducing damage to the servo 100 and/or the load 106.

FIG. 7B shows an example of slipping motion. In the example shown, the disc 202 is rotating slowly enough that the cam 224 does not skip and is in the path 268 of the teeth 206. In this slipping motion, the input torque from the spinning disc 202 may be high enough to overcome the preload of the first resilient element 232 that biases the cam 224 toward a neutral position (e.g., as shown in FIG. 6). When this action happens, the cam 224 rotates in a radial direction 266 a sufficient amount that the tooth 206 can pass by the cam 224. After the tooth 206 passes, the first resilient element 232 causes the cam 224 to rotate back toward the neutral position until another tooth 206 contacts the cam 224 at a contact point 262. This process may repeat until the input torque from the disc 202 is no longer sufficiently large to cause the cam 224 to rotate out of the tooth 206 path 268. At this point, the braking assembly is deployed and the motor stops spinning.

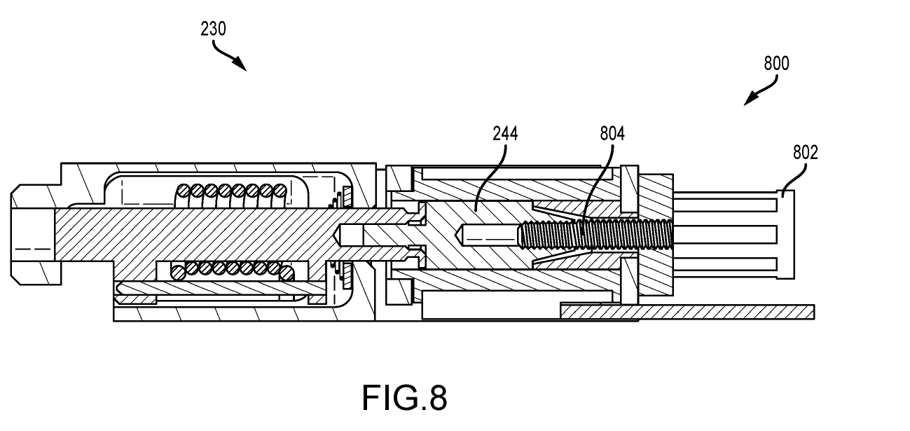

FIG. 8 shows an example of a removal tool 800 suitable to disengage a braking assembly such as the braking assembly 200, or another braking assembly disclosed herein. The removal tool 800 includes a knob 802 coupled to a threaded portion 804. The threaded portion 804 engages complementary threads in the armature 244. As the knob 802 is rotated (e.g., clockwise), the threaded portion 804 pulls the armature 244, and thus the pin 216 and cam 224 away from the disc 202 to disengage the cam 224 and the disc 202.

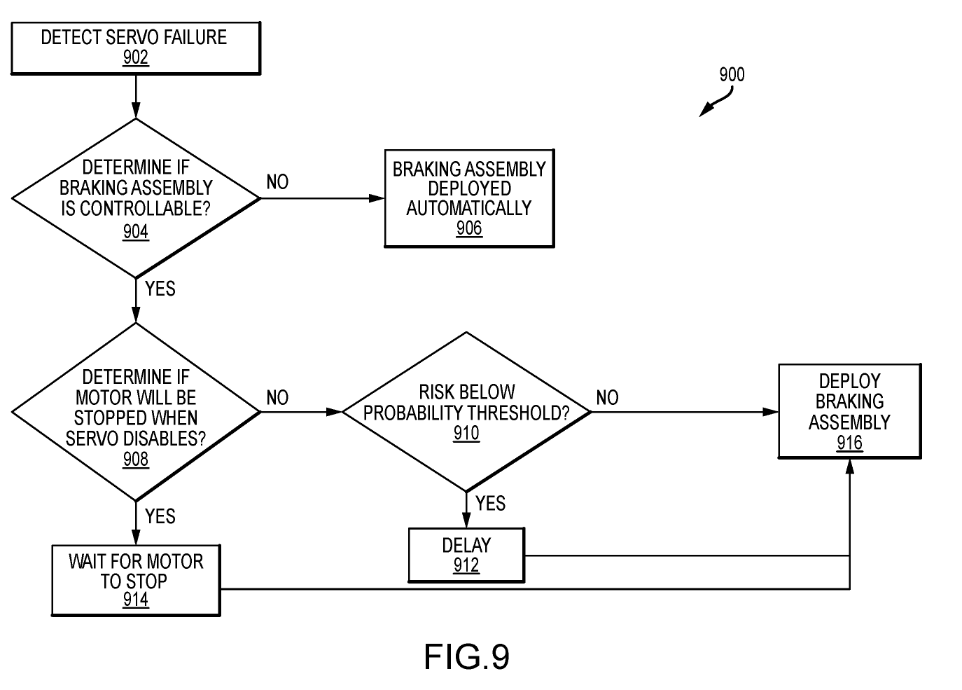

FIG. 9 illustrates an example method 900 for deploying any braking assembly disclosed herein, such as the braking assembly 200, the braking assembly 1000, the braking assembly 1100, the braking assembly 1200, the braking assembly 1300, and/or the braking assembly 1400. Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

According to some examples, the method 900 includes detecting servo 100 failure at block 902. For example, a processing element 1502 of a system in which the braking assembly 200 is used, or a processing element 1502 of the drive 108 may report a failure or impending failure of the braking assembly 200.

According to some examples, the method 900 includes determining if the braking assembly is controllable at operation 904. For example, a processing element 1502 may determine that the braking assembly is not controllable (e.g., has no power). If the braking assembly 200 is controllable, the method 900 may proceed to operation 908. If the braking assembly 200 is not controllable, the method 900 may proceed to operation 906.

According to some examples, the method 900 includes automatically deploying the braking assembly at operation 906. As described herein, where the cam 224 is biased into the path 268 of the teeth 206 when the coil 240 is not powered (e.g., by a biasing element or the second resilient element 236), loss of power automatically pushes the cam 224 into the path 268 of the teeth 206 and the cam will begin skipping and/or slipping as described herein.

According to some examples, the method 900 includes determining if the motor 102 will be stopped when the servo 100 disables at operation 908. For example, a processing element 1502 may determine, based on appropriate sensors or the like that the motor 102 will or will not be spinning when the servo 100 fails. Additionally or alternately, the processing element 1502 may determine a speed at which the motor 102 is likely to be spinning when the servo 100 disables. If the motor 102 is likely to be stopped when the servo 100 disables, the method 900 may proceed to operation 914. If the motor 102 is not likely to be stopped when the servo 100 disables, the method 900 may proceed to operation 910.

According to some examples, the method 900 includes determining a damage risk to the servo 100 at operation 910. The damage risk estimate may be based on a speed, direction, and/or torque of the disc 202 and/or motor 102. If the risk of damage is below a probability threshold the method 900 may proceed to operation 912 and delay deployment of the braking assembly. If the risk of damage to the servo 100 is at or above a probability threshold, the method 900 may proceed to operation 916 and deploy the braking assembly.

According to some examples, the method 900 includes delaying deployment of the braking assembly at operation 912. The delay in deployment may be based on one or more of a predetermined time, the motor 102 and/or disc 202 dropping below a motion threshold, such as a speed and/or torque threshold, or combinations of these. Once the time has elapsed or the motion threshold has been met, the method 900 may proceed to operation 916 and deploy the braking assembly.

According to some examples, the method 900 includes waiting for the motor 102 to stop at operation 914. For example, the processing element 1502 may wait for a certain predetermined time for the motor 102 to stop, and/or may monitor a sensor to determine that the motor 102 is no longer spinning.

According to some examples, the method 900 includes deploying braking assembly at operation 916. Deploying the braking assembly may be as discussed above. For example, the coil 240 of the solenoid 230 may be de-energized allowing the second resilient element 236 or biasing element to push the cam 224 into the path 268 of the teeth 206. In other embodiments, such as where the cam 224 is biased inward away from the disc 202, the coil 240 may be energized to force the cam into the path 268 of the teeth 206.

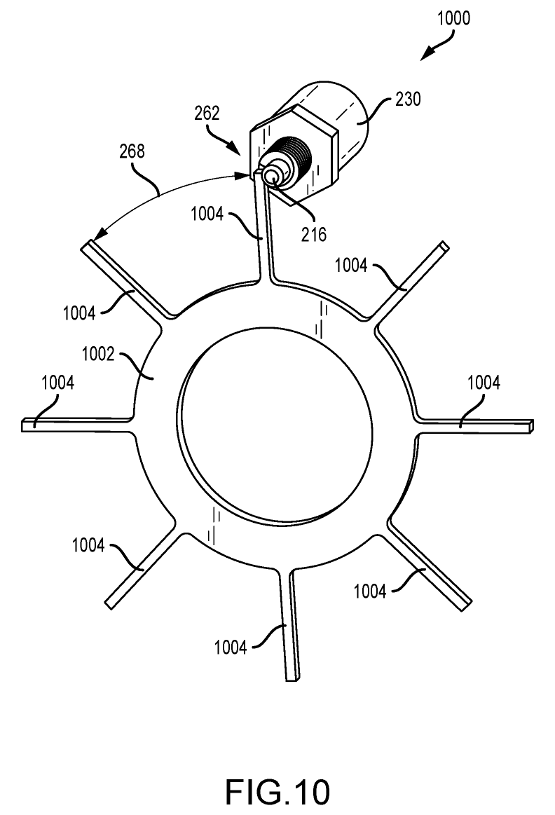

Turning to FIG. 10, an embodiment of a servo braking assembly 1000 is shown. The braking assembly 1000 includes a solenoid 230 as described. The disc 1002 of the braking assembly 1000 includes a plurality of compliant tines 1004. A complaint tine 1004 is one that can bend elastically when contacting the pin 216. For example, a compliant tine 1004 may contact the pin 216 at the contact point 262, bend elastically to the point the compliant tine 1004 slips past the pin 216, and once past the pin 216 the compliant tine 1004 may return to its original shape before the contact with the pin 216. The pin 216 of the solenoid 230 can be selectively deployed into the path 268 of the compliant tines 1004. The relatively long, slender shape of the compliant tine 1004 may provide some level of flex and compliance to the braking assembly 1000 as the pin 216 engages the compliant tines 1004 at a contact point 262. For example, the compliant tines 1004 may deflect or bend sufficiently to allow the compliant tine 1004 to slip past the pin 216, in a slipping motion similar to that described for the braking assembly 200. In some embodiments, the braking assembly 1000 may also be used with portions of the braking assembly 200, such as the cam 224, the first resilient element 232, and/or the second resilient element 236, etc., such that the pin 216 can skip and/or slip with respect to the tines 1004, as described herein with respect to the teeth 206 of the disc 202. An advantage of such an embodiment includes lower stress on the pin 216 and cam 224 due to the elastic bending of the tines.

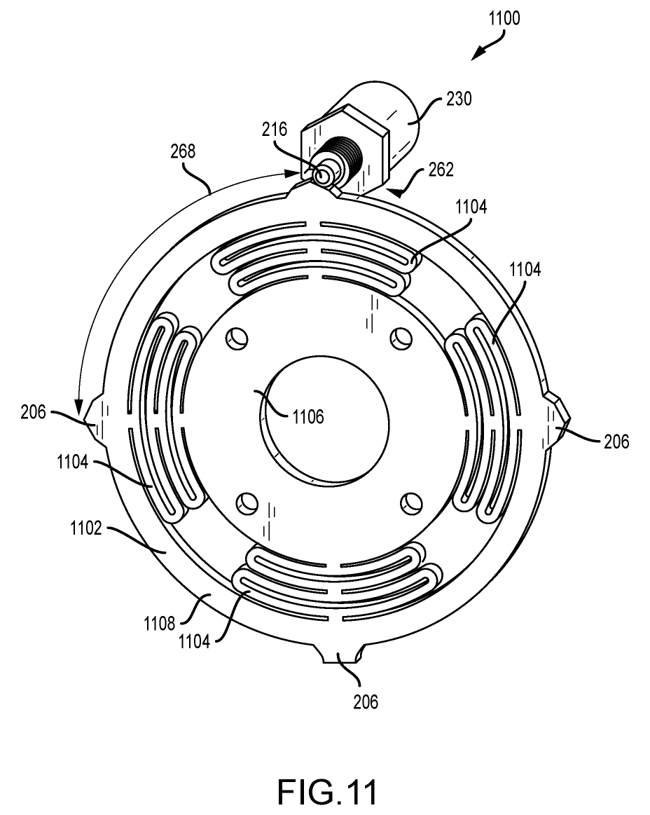

Turning to FIG. 11, a braking assembly 1100 is shown. The braking assembly 1100 includes a solenoid 230 and a disc 1102. The disc 1102 includes an inner hub 1106 and an outer hub 1108. The inner hub 1106 and outer hub 1108 are coupled to one another by one or more disc resilient elements 1104. The inner hub 1106 is coupled to the shaft 104 of the motor 102. The outer hub 1108 interacts with the pin 216. The outer circumferential edge of the outer hub 1108 includes one or more teeth 206 protruding radially therefrom. As the teeth 206 contact the pin 216 at the contact point 262, the inner hub 1106 and outer hub 1108 deflect angularly with respect to one another (e.g., with the inner hub 1106 leading the outer hub 1108 in the direction of rotation of the motor 102). Once the inner hub 1106 and outer hub 1108 deflect sufficiently, the tooth 206 may slip past the pin 216 in a slipping motion similar to that described for the braking assembly 200.

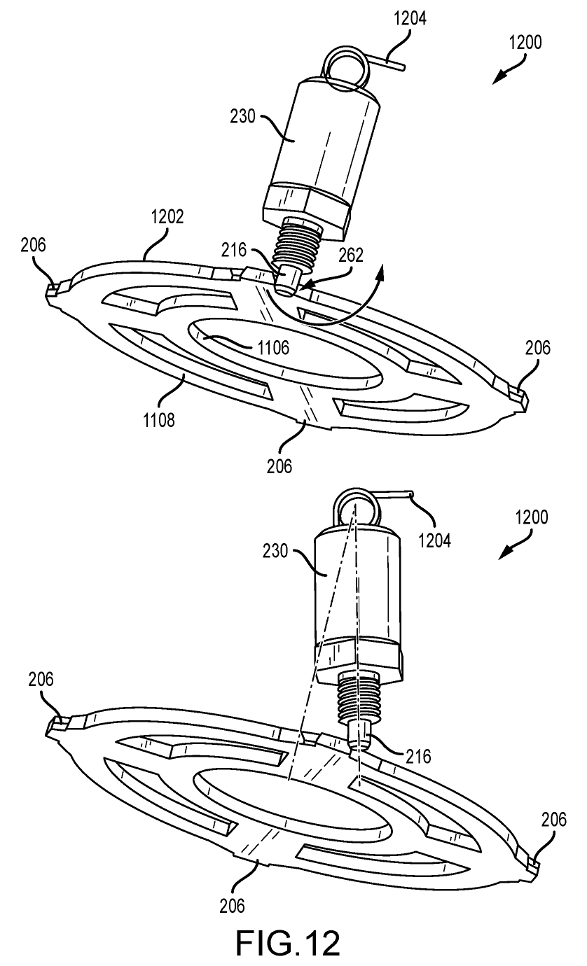

Turning to FIG. 12, a braking assembly 1200 is shown. The braking assembly 1200 includes a solenoid 230 and a disc 1202. Like the disc 1102, the disc 1202 may have an inner hub 1106 and an outer hub 1108 that have some level of compliance with respect to one another. The outer circumferential edge of the outer hub 1108 includes one or more teeth 206 protruding radially therefrom. The braking assembly 1200 includes a resilient element 1204 that the solenoid 230 is mounted to. In this example, the resilient element 1204 is a coil spring. As the pin 216 contacts a tooth 206 at a contact point 262, the resilient element 1204 flexes to enable the solenoid 230 to move an angular displacement such that the tooth 206 can pass by the pin 216 in a slipping motion similar to that described for the braking assembly 200.

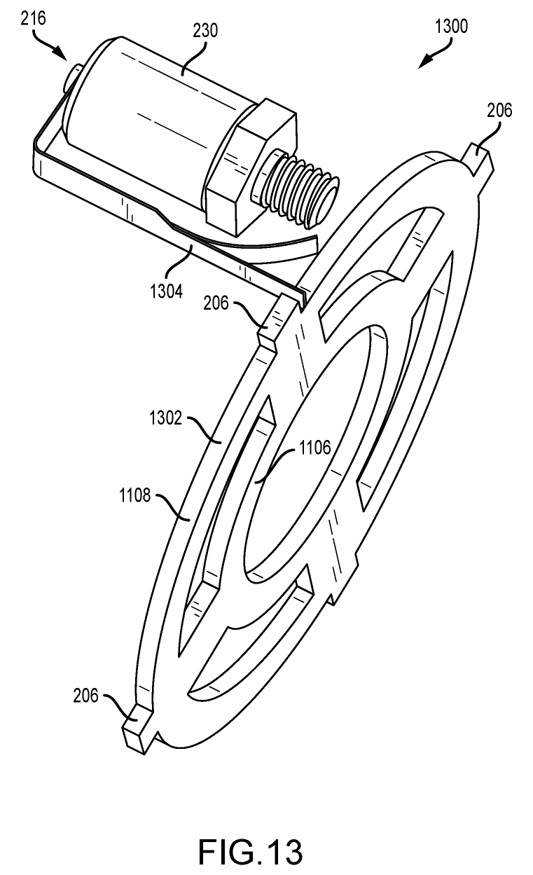

Turning to FIG. 13, a braking assembly 1300 is shown. The braking assembly 1300 includes a solenoid 230 and a disc 1302. Like the disc 1102 and the disc 1202, the disc 1302 may have an inner hub 1106 and an outer hub 1108 that have some level of compliance with respect to one another. The outer circumferential edge of the outer hub 1108 includes one or more teeth 206 protruding radially therefrom. The braking assembly 1300 includes a resilient element 1304 mounted to the pin 216. The solenoid 230 in this example is rotated 180° with respect to the other brake assemblies shown (e.g., the pin 216 points away from the disc 202). In this example, the resilient element 1304 is a leaf spring. To deploy the braking assembly 1300, the pin 216 is retracted to place the resilient element 1304 in the path 268 of the teeth 206. The resilient element 1304 flexes as the teeth 206 contact it, allowing the teeth 206 to push past the resilient element 1304 in a slipping motion similar to that described for the braking assembly 200.

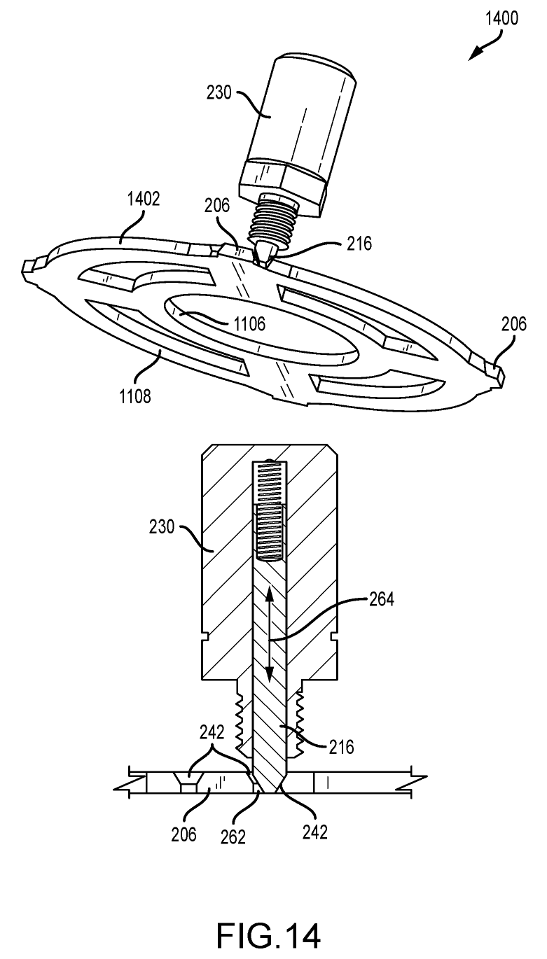

Turning to FIG. 14, a braking assembly 1400 is shown. The braking assembly 1400 includes a solenoid 230 and a disc 1402. Like the disc 1102, the disc 1202, and the disc 1302, the disc 1402 may have an inner hub 1106 and an outer hub 1108 that have some level of compliance with respect to one another. The outer circumferential edge of the outer hub 1108 includes one or more teeth 206 protruding radially therefrom. The braking assembly 1400 may optionally include a resilient element. Although, in many embodiments, the braking assembly 1400 does not include a resilient element.

The pin 216 of the solenoid 230 in the braking assembly 1400 includes one or more bevels 242 that complement bevels 242 on the teeth 206. As the pin 216 contacts a tooth 206 at a contact point 262, the bevels 242 interact to push the pin 216 toward the solenoid 230 body in a skipping motion similar to that described with respect to the braking assembly 200.

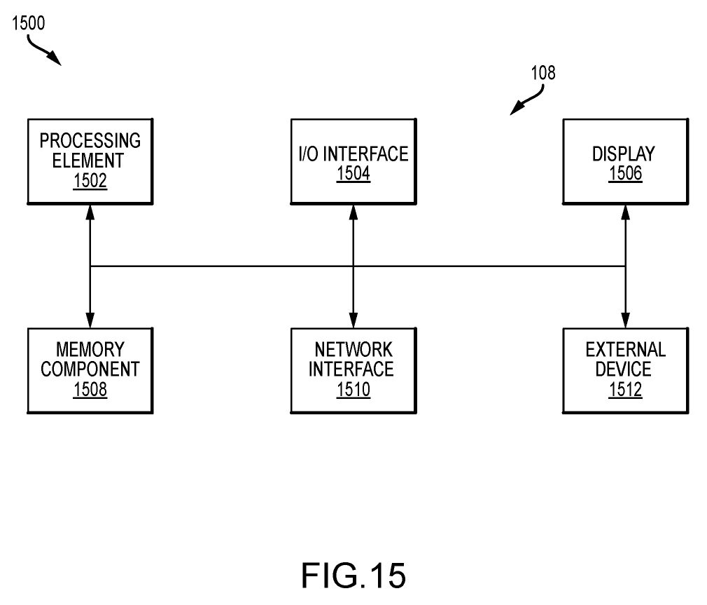

FIG. 15 is a simplified block diagram of components of a computing system 1500 of the servo 100 such as a drive 108 or another control system that controls the brake assemblies disclosed or executes the method 900. For example, the processing element 1502 and the memory component 1508 may be located at one or in several computing systems 1500. This disclosure contemplates any suitable number of such computing systems 1500. For example, the computing system 1500 may be a desktop computing system, a mainframe, a blade, a mesh of computing systems 1500, a laptop or notebook computing system 1500, a tablet computing system 1500, an embedded computing system 1500, a system-on-chip, a single-board computing system 1500, or a combination of two or more of these. Where appropriate, a computing system 1500 may include one or more computing systems 1500; be unitary or distributed; span multiple locations; span multiple machines; span multiple data centers; or reside in a cloud, which may include one or more cloud components in one or more networks. A computing system 1500 may include one or more processing elements 1502, an input/output I/O interface 1504, one or more external devices 1512, one or more memory components 1508, and a network interface 1510. Each of the various components may be in communication with one another through one or more buses or communication networks, such as wired or wireless networks, e.g., network. The components in FIG. 15 are exemplary only. In various examples, the computing system 1500 may include additional components and/or functionality not shown in FIG. 15.

The processing element 1502 may be any type of electronic device capable of processing, receiving, and/or transmitting instructions. For example, the processing element 1502 may be a central processing unit, microprocessor, processor, or microcontroller. Additionally, it should be noted that some components of the computing system 1500 may be controlled by a first processing element 1502 and other components may be controlled by a second processing element 1502, where the first and second processing elements may or may not be in communication with each other.

The I/O interface 1504 allows a user to enter data in to computing system 1500, as well as provides an input/output for the computing system 1500 to communicate with other devices or services. The I/O interface 1504 can include one or more input buttons, touch pads, touch screens, and so on.

The external device 1512 are one or more devices that can be used to provide various inputs to the computing systems 1500, e.g., mouse, microphone, keyboard, trackpad, sensing element (e.g., a thermistor, humidity sensor, light detector, etc. The external devices 1512 may be local or remote and may vary as desired. In some examples, the external devices 1512 may also include one or more additional sensors.

The memory components 1508 are used by the computing system 1500 to store instructions for the processing element 1502 such as the instructions that execute the method 900, user preferences, alerts, etc. The memory components 1508 may be, for example, magneto-optical storage, read-only memory, random access memory, erasable programmable memory, flash memory, or a combination of one or more types of memory components.

The network interface 1510 provides communication to and from the computing system 1500 to other devices. The network interface 1510 includes one or more communication protocols, such as, but not limited to Wi-Fi, Ethernet, Bluetooth, etc. The network interface 1510 may also include one or more hardwired components, such as a Universal Serial Bus (USB) cable, or the like. The configuration of the network interface 1510 depends on the types of communication desired and may be modified to communicate via Wi-Fi, Bluetooth, etc.

The display 1506 provides a visual output for the computing system 1500 and may be varied as needed based on the device. The display 1506 may be configured to provide visual feedback to a user and may include a liquid crystal display screen, light emitting diode screen, plasma screen, or the like. In some examples, the display 1506 may be configured to act as an input element for a user through touch feedback or the like.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader’s understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An electric motor braking assembly comprising:
a disc coupled to a motor shaft, the disc having a circumferential array of teeth;
an actuator assembly including:
a pin selectively deployable to interfere with at least one tooth of the circumferential array of teeth,
a solenoid configured to move the pin between a deployed position in which the pin interferes with the at least one tooth of the circumferential array of teeth, and a retracted position in which the pin does not interfere with the at least one tooth of the circumferential array of teeth, and
a first resilient element coupled to at least one of the pin or the disc and configured to allow a rotational slipping motion of the pin relative to the at least one tooth of the circumferential array of teeth when the pin is in the deployed position.

2. The electric motor braking assembly of claim 1, further comprising a second resilient element configured to allow a longitudinal skipping motion of the pin relative to the at least one tooth of the circumferential array of teeth.

3. The electric motor braking assembly of claim 1, wherein the disc includes an inner hub and an outer hub connected by a resilient element that allows angular movement therebetween.

4. The electric motor braking assembly of claim 2, wherein at least one of the first resilient element or the second resilient element comprises a coil spring.

5. The electric motor braking assembly of claim 1, wherein the pin includes a body with a head portion at one end of the body and a tail portion at an opposite end of the body.

6. The electric motor braking assembly of claim 5, wherein the pin includes a cam adjacent to the head portion configured to engage with the at least one tooth of the circumferential array of teeth.

7. The electric motor braking assembly of claim 6, wherein the at least one tooth of the circumferential array of teeth includes a tooth bevel, and the cam includes a complementary cam bevel.

8. The electric motor braking assembly of claim 7, wherein the cam bevel and the tooth bevel are configured to meet at a contact point when the pin is in the deployed position.

9. The electric motor braking assembly of claim 6, wherein the body includes a bulkhead extending therefrom, and the pin further comprises a retainer extending between the cam and the bulkhead.

10. The electric motor braking assembly of claim 5, wherein the body includes a bulkhead extending therefrom, and the bulkhead is configured to pretension the first resilient element.

11. The electric motor braking assembly of claim 1, wherein the first resilient element comprises a torsion spring.

12. The electric motor braking assembly of claim 2, wherein the second resilient element comprises a compression spring.

13. The electric motor braking assembly of claim 2, wherein the first resilient element comprises a torsion spring, and the second resilient element comprises a compression spring.

14. A removal tool for use with the electric motor braking assembly of claim 1, wherein the removal tool is configured to disengage the electric motor braking assembly, the removal tool comprising: a threaded portion coupled to a knob.

15. The removal tool of claim 14, wherein the threaded portion is configured to engage an armature of the solenoid to draw the pin away from the disc.

16. A method of operating a braking assembly, comprising:
detecting, via a processing element, a failure condition in a servo system;
determining, via the processing element, whether the braking assembly is controllable;
responsive to determining that the braking assembly is controllable, evaluating, via the processing element, a risk of damage to the braking assembly;
delaying, via the processing element, deployment of the braking assembly until the risk of damage is below a threshold.

17. The method of claim 16, wherein the braking assembly further comprises a pin and a disc, the disc including a circumferential array of teeth, the method further comprising: responsive to determining, via the processing element, that the braking assembly is not controllable, automatically deploying the braking assembly by moving the pin to a deployed position that allows a rotational slipping motion of the pin relative to at least one tooth of the circumferential array of teeth.

18. The method of claim 16, wherein the braking assembly further comprises a pin, a disc having a circumferential array of teeth, and a first resilient element coupled to the pin, and
wherein the method further comprises deploying the braking assembly by moving the pin to a deployed position that allows a rotational slipping motion of the pin relative to at least one tooth of the circumferential array of teeth.

19. The method of claim 18, wherein the braking assembly further comprises a second resilient element, and
wherein the method further comprises deploying the braking assembly by moving the pin to a deployed position that allows a longitudinal skipping motion of the pin relative to the at least one tooth of the circumferential array of teeth when the pin is in the deployed position.

20. An electric motor braking assembly comprising:
a disc coupled to a motor shaft, the disc having a circumferential array of tines;
an actuator assembly including:
a pin selectively deployable to interfere with at least one tine of the circumferential array of tines,
a solenoid configured to move the pin between a deployed position in which the pin interferes with the at least one tine of the circumferential array of tines, and a retracted position in which the pin does not interfere with the at least one tine of the
circumferential array of tines, wherein the tines of the circumferential array of tines are configured to allow a rotational slipping motion of the pin relative to the at least one tine of the circumferential array of tines when the pin is in the deployed position.
